(19) United States
(12) Patent Application Publication
(10) Pub. No.: US 2025/0154674 A1
(43) Pub. Date: May 15, 2025

(54) MEMBRANE-ELECTRODE ASSEMBLY AND MANUFACTURING METHOD THEREOF

(71) Applicant: SAMSUNG ELECTRO-MECHANICS CO., LTD., Suwon-si (KR)

(72) Inventors: Tae Jun CHOI, Suwon-si (KR); Byung Chul JANG, Suwon-si (KR); Sun Il JEONG, Suwon-si (KR); Hae Sol JUNG, Suwon-si (KR); Guh Hwan LIM, Suwon-si (KR)

(73) Assignee: SAMSUNG ELECTRO-MECHANICS CO., LTD., Suwon-si (KR)

(21) Appl. No.: 18/821,504

(22) Filed: Aug. 30, 2024

(30) Foreign Application Priority Data
Nov. 13, 2023 (KR) 10-2023-0156300

(51) Int. Cl. C25B 13/08; C25B 1/04; C25B 9/23; C25B 11/032

(52) U.S. Cl. CPC C25B 13/08; C25B 1/04; C25B 9/23; C25B 11/032

(57) ABSTRACT

A membrane-electrode assembly includes a first catalyst electrode, a polymer electrolyte membrane covering a side surface and an upper surface of the first catalyst electrode, and a second catalyst electrode disposed on the polymer electrolyte membrane, in which at least a portion of a corner area in which the side surface and the upper surface of the first catalyst electrode are connected has a curved shape.

### CROSS-REFERENCE TO RELATED APPLICATION(S)

This application claims the benefit of priority to Korean Patent Application No. 10-2023-0156300 filed on Nov. 13, 2023 in the Korean Intellectual Property Office, the disclosure of which is incorporated herein by reference in its entirety.

### TECHNICAL FIELD

The present disclosure relates to a membrane-electrode assembly.

### BACKGROUND

A polymer electrolyte membrane fuel cell and a polymer electrolyte membrane water electrolysis cell are eco-friendly energy source devices using hydrogen and are attracting attention because they are highly efficient and can be miniaturized. The polymer electrolyte membrane fuel cell and the polymer electrolyte membrane water electrolytic cell generally include a membrane-electrode assembly (MEA) in which a polymer electrolyte membrane is disposed between catalyst electrodes, and the performance of the membrane-electrode assembly greatly influences the performance of a fuel cell or water electrolysis cell.

Such membrane-electrode assembly is generally implemented by a method of thermocompressing a catalyst electrode sheet on both surfaces of a polymer electrolyte membrane, a method of applying a catalyst electrode paste to both surfaces of a polymer electrolyte membrane, etc. Thereamong, the thermocompression method has problems such as difficulty in maintaining porosity of the catalyst electrode to be high during the thermocompression process and the need for a separate support to be installed inside the electrolyte membrane to ensure that the electrolyte membrane has high rigidity. The method of applying paste has problems such as swelling of the electrolyte membrane due to the absorption of the paste into the electrolyte membrane, leading to the necessity of inverting the electrolyte membrane to proceed with the application process on both surfaces, and needing to install a separate support inside the electrolyte membrane, like the heat compression method.

### SUMMARY

An aspect of the present disclosure is to implement a membrane-electrode assembly in which an electrolyte membrane may have a high level of ionic conductivity and reaction efficiency may be improved. However, an object of the present disclosure is not limited to the above-mentioned object and will be realized by means and combinations thereof described in the claims.

According to an aspect of the present disclosure, a membrane-electrode assembly includes: a first catalyst electrode; a polymer electrolyte membrane covering a side surface and an upper surface of the first catalyst electrode; and a second catalyst electrode disposed on the polymer electrolyte membrane, in which at least a portion of a corner area in which the side surface and the upper surface of the first catalyst electrode are connected has a curved shape.

The side surface of the first catalyst electrode may have an inclined surface inclined with respect to an upper or lower surface of the polymer electrolyte membrane.

A side surface of the polymer electrolyte membrane may be disposed to be perpendicular with respect to an upper or lower surface of the polymer electrolyte membrane.

The side surface and the upper surface of the first catalyst electrode may have a higher surface roughness than a side surface of the polymer electrolyte membrane.

At least a portion of the corner area in which the side surface and the upper surface of the second catalyst electrode are connected may have a curved shape.

The side surface of the second catalyst electrode may have an inclined surface inclined with respect to an upper or lower surface of the polymer electrolyte membrane.

The side surface and the upper surface of the second catalyst electrode may have a higher surface roughness than a side surface of the polymer electrolyte membrane.

The polymer electrolyte membrane may cover a side surface of the second catalyst electrode.

A width of the second catalyst electrode may be wider than that of the first catalyst electrode.

The second catalyst electrode and the polymer electrolyte membrane may have substantially the same width.

The side surface and the upper surface of the first catalyst electrode may have a higher surface roughness than a side surface of the polymer electrolyte membrane and a side surface of the second catalyst electrode.

The membrane-electrode assembly may further include a first gas diffusion layer disposed below the first catalyst electrode; and a second gas diffusion layer disposed over the second catalyst electrode.

The membrane-electrode assembly may further include a spacer disposed between the polymer electrolyte membrane and the second gas diffusion layer to surround the second catalyst electrode.

According to another aspect of the present disclosure, a membrane-electrode assembly includes: a first catalyst electrode; a polymer electrolyte membrane covering a side surface and an upper surface of the first catalyst electrode; and a second catalyst electrode disposed on the polymer electrolyte membrane, in which the side surface and the upper surface of the first catalyst electrode have a higher surface roughness than a side surface of the polymer electrolyte membrane.

A side surface and an upper surface of the second catalyst electrode may have a higher surface roughness than the side surface of the polymer electrolyte membrane.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is an exploded perspective view schematically illustrating a membrane-electrode assembly according to an example embodiment of the present disclosure;

FIG. 2 is a cross-sectional view of one area of the membrane-electrode assembly;

FIG. 3 is an enlarged view of components of the membrane-electrode assembly;

FIGS. 4 through 9 are diagrams illustrating a membrane-electrode assembly according to modifications; and

FIGS. 10 through 13 are diagrams illustrating an example of a method of manufacturing a membrane-electrode.

### DETAILED DESCRIPTION

Hereinafter, example embodiments will be described in detail with reference to the accompanying drawings. However, example embodiments may be modified in various other forms, and the scope of the present disclosure is not limited to example embodiments to be described below. Further, example embodiments are provided in order to more completely explain the present disclosure to those skilled in the art. In the drawings, the shapes and dimensions may be exaggerated for clarity, and the same reference numerals will be used throughout to designate the same or like components.

In the drawings, parts not related to the description are omitted in order to clearly describe the present disclosure, a thickness has been enlarged in order to clearly express several layers and areas, and the same components having the same function within the scope of the same idea are described using the same reference numerals. Furthermore, throughout the present specification, unless explicitly described to the contrary, “comprising” any components will be understood to imply the inclusion of other elements rather than the exclusion of any other elements.

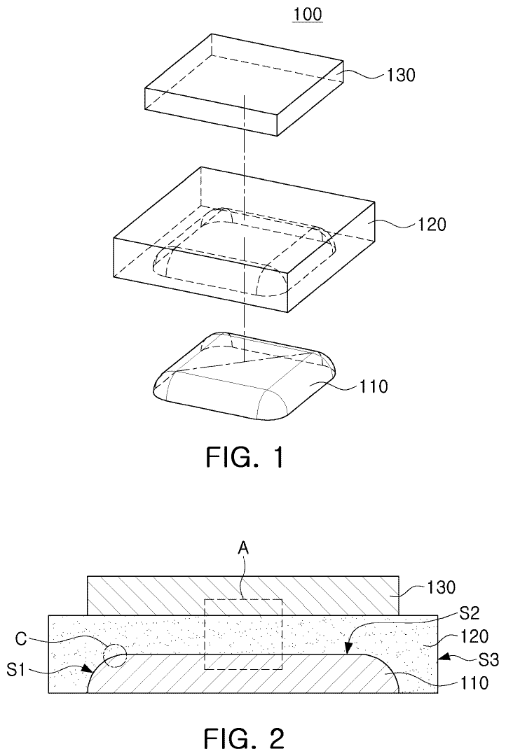

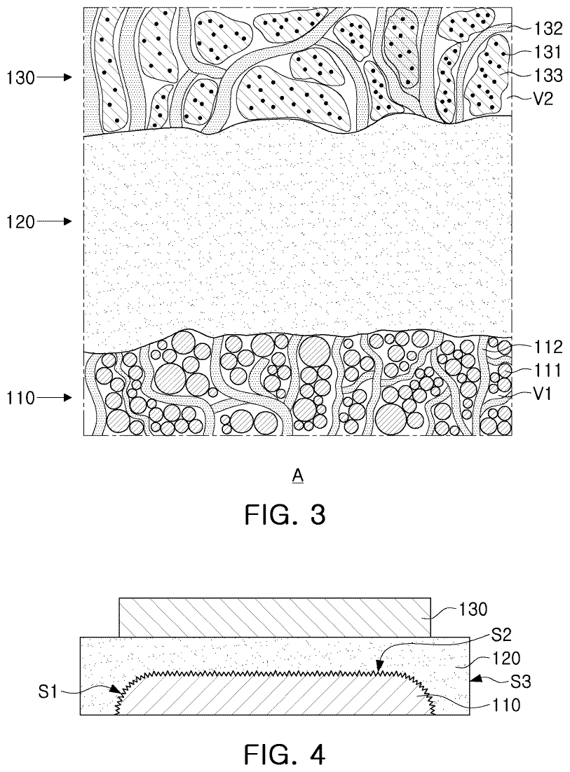

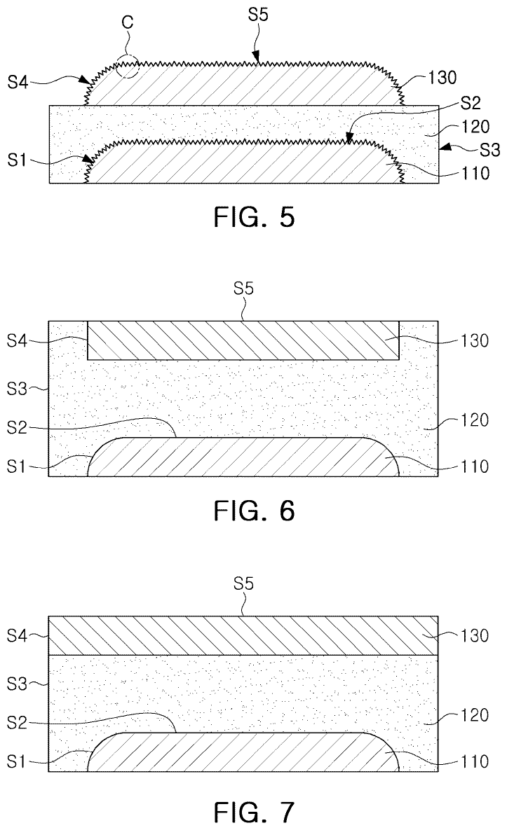

FIG. 1 is an exploded perspective view schematically illustrating a membrane-electrode assembly according to an example embodiment of the present disclosure. FIG. 2 is a cross-sectional view of one area of the membrane-electrode assembly. FIG. 3 is an enlarged view of components of the membrane-electrode assembly.

Referring to FIGS. 1 and 2, a membrane-electrode assembly 100 according to an example embodiment of the present disclosure includes a first catalyst electrode 110, a polymer electrolyte membrane 120, and a second catalyst electrode 130 as main components, in which at least a portion of a corner area C where a side surface and an upper surface of the first catalyst electrode 110 are connected are implemented in a curved shape. As will be described later, the first catalyst electrode 110 having this shape may be formed by a method of forming the first catalyst electrode 110 after stacking general sheets and then forming the polymer electrolyte membrane 120 to cover the side surface and the upper surface, rather than a thermocompression process, so an interface between the first catalyst electrode 110 and the polymer electrolyte membrane 120 increases, thereby improving reaction efficiency when used as a fuel cell, a water electrolysis cell, etc. In addition, since there is no need to provide a support inside the polymer electrolyte membrane 120, an ionic conductivity of the polymer electrolyte membrane 120 may be maintained at a high value. These advantages may greatly contribute to improving characteristics of the membrane-electrode assembly 100. Hereinafter, the components of the membrane-electrode assembly 100 will be described in detail, focusing on the case where the membrane-electrode assembly 100 is the water electrolysis cell. However, the membrane-electrode assembly 100 may be used as the fuel cell. In this case, the opposite reaction will occur when the first catalyst electrode 110 and the second catalyst electrode 130 of the membrane-electrode assembly 100 are used as the water electrolysis battery.

The first catalyst electrode 110 includes a first catalyst 111 and may include an aggregate of particles of the first catalyst 111 as illustrated in FIG. 3. In addition to the first catalyst 111, the first catalyst electrode 110 may include an ion conductor 112, and the ion conductor 112 may function as a binder for the first catalyst 111. In addition, pores V1 may be formed within the first catalyst electrode 110 to allow gas, liquid, etc., to move smoothly. The first catalyst 111 is active in the oxygen generation reaction and may include Ir-based, Ru-based, or Ti-based materials. The ion conductor 112 may provide a movement path for hydrogen ions generated in the first catalyst electrode 110, and may include, for example, a fluorine-based ionomer, a carbon-hydrogen-based ionomer, or a mixture thereof. As a specific example, the ion conductor 112 may include a perfluorinated sulfonic acid ionomer. In the case of the water electrolysis cell, the first catalyst electrode 110 is an anode, and water supplied to the anode may be separated into oxygen (O₂), hydrogen ions (H+, protons), and electrons. Here, hydrogen ions may move to the second catalyst electrode 130 through the polymer electrolyte membrane 120, and electrons may move to the second catalyst electrode 130 through an external circuit and a power supply.

The polymer electrolyte membrane 120 may include the ion conductor to provide the movement path for the hydrogen ions, etc. Here, the ion conductor of the polymer electrolyte membrane 120 may include, for example, a fluorine-based ionomer, a carbon-hydrogen-based ionomer, a mixture thereof, etc. As a specific example, the ion conductor 112 may include a perfluorinated sulfonic acid ionomer. In the case of the water electrolysis cell, the hydrogen ions generated in the first catalyst electrode 110 may move to the second catalyst electrode 130 through the polymer electrolyte membrane 120. As illustrated, the polymer electrolyte membrane 120 covers a side surface S1 and an upper surface S2 of the first catalyst electrode 110, thereby increasing an interface between the side surface S1 and the upper surface S2. When the interface between the polymer electrolyte membrane 120 and the first catalyst electrode 110 increase in this way, the material exchange between the polymer electrolyte membrane 120 and the first catalyst electrode 110 become active and the reaction efficiency in the catalyst electrodes 110 and 130 may be improved.

The second catalyst electrode 130 includes a second catalyst 131 and is disposed on the polymer electrolyte membrane 120. In this case, as illustrated in FIG. 3, the second catalyst 131 may be provided in a form supported on a support 133. In addition, the second catalyst electrode 130 may include an ion conductor 132, and the ion conductor 132 may function as a binder for the support 133 with the second catalyst 131. In addition, pores V2 may be formed within the second catalyst electrode 130 to allow gas, liquid, etc., to move smoothly. The second catalyst 131 is active in hydrogen oxidation reaction or oxygen reduction reaction and may include platinum (Pt), gold (Au), ruthenium (Ru), osmium (Os), palladium (Pd), and alloys thereof. The ion conductor 132 may provide the movement path for hydrogen ions, etc., and may include, for example, a fluorine-based ionomer, a carbon-hydrogen-based ionomer, a mixture thereof, etc. As a specific example, the ion conductor 132 may include a perfluorinated sulfonic acid ionomer. The support 133 may be formed of a porous material with a high surface area to support a large amount of the second catalyst 131. For example, a carbon-based support may be used. In the case of the water electrolysis cell, the second catalyst electrode 130 is a cathode, and hydrogen ions supplied through the polymer electrolyte membrane 120 may react with electrons to generate hydrogen.

Meanwhile, in the above description, the case where the first catalyst electrode 110 and the second catalyst electrode 130 are an anode and a cathode, respectively, is used as an example, but the opposite structure is also possible. That is, as a modification, in the membrane-electrode assembly 100, the first catalyst electrode 110 may be a cathode and the second catalyst electrode 130 may be an anode.

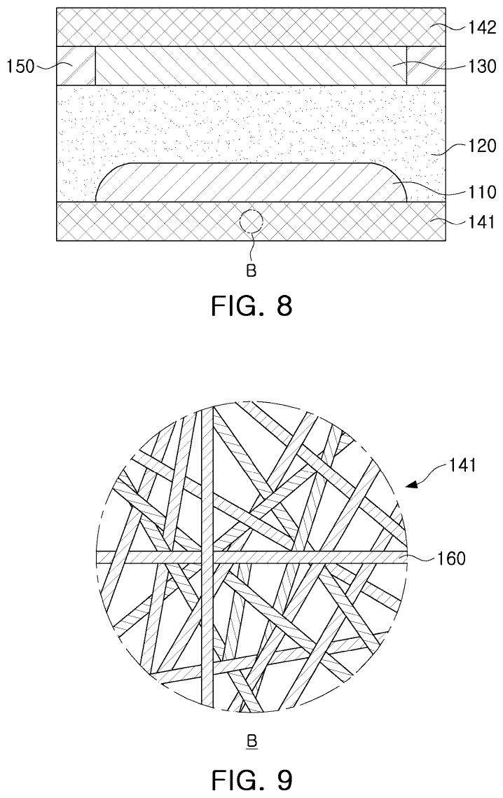

The shapes of the first catalyst electrode 110 and the polymer electrolyte membrane 120 will be described in more detail. In the case of this example embodiment, as described above, the polymer electrolyte membrane 120 covers the side surface S1 and the upper surface S2 of the first catalyst electrode 110, and at least a portion of a corner area C where the side surface S1 and the upper surface S2 of the first catalyst electrode 110 are connected has a curved shape. In this case, the side surface S1 of the first catalyst electrode 110 may have an inclined surface inclined with respect to an upper or lower surface of the polymer electrolyte membrane 120. In this way, the side surface S1 and the upper surface S2 of the first catalyst electrode 110 are not disposed to be perpendicularly to each other, but a curved surface is formed in the corner area C, which may be obtained when the first catalyst electrode 110 is formed on a carrier film by a printing process, as will be described later. In this case, the first catalyst electrode 110 may not be cut when individualized, and thus the side surface S1 and upper surface S2 of the first catalyst electrode 110 may maintain high roughness and the corner area C may have a curved shape. Therefore, as illustrated in FIG. 4, the side surface S1 and the upper surface S2 of the first catalyst electrode 110 may have higher surface roughness than a side surface S3 of the polymer electrolyte membrane 120. In addition, when the first and second catalyst electrodes 110 and 130 are directly formed on the surface of the polymer electrolyte membrane 120, it may be difficult to sufficiently secure the interface between the first and second catalyst electrodes 110 and 130. As in the present example embodiment, by forming the polymer electrolyte membrane 120 to cover the side surface and the upper surface of the first catalyst electrode 110, the interface between the side surface and the upper surface may be expanded and the reaction efficiency may be improved.

As illustrated, the side surface S3 of the polymer electrolyte membrane 120 may be disposed to be perpendicular to the upper or lower surface of the polymer electrolyte membrane 120. As will be described later, unlike the first catalyst electrode 110, the polymer electrolyte membrane 120 may be integrally formed and then undergo a cutting process for individualization, and thus, the side surface S3 may be vertically disposed. In addition, as a result, the polymer electrolyte membrane 120 may have a relatively low roughness, and the side surface S3 of the polymer electrolyte membrane 120 may have lower roughness than the side surface S1 and upper surface S2 of the first catalyst electrode 110.

Hereinafter, the membrane-electrode assemblies according to modified example embodiments will be described with reference to FIGS. 5 through 9. The following modifications may be combined with the basic example embodiment singly or combined with each other.

In the case of the example embodiment of FIG. 5, like the first catalyst electrode 110, at least a portion of the corner area C where a side surface S4 and an upper surface S5 of the second catalyst electrode 130 are connected may have a curved shape. In this case, the side surface S4 of the second catalyst electrode 130 may have an inclined surface inclined with respect to the upper or lower surface of the polymer electrolyte membrane 120. As will be described later, the second catalyst electrode 130 may be obtained by the printing process on the polymer electrolyte membrane 120. In this case, similar to the first catalyst electrode 110, the second catalyst electrode 130 may not be cut when individualized. Accordingly, in the second catalyst electrode 130, the side surface S4 and the upper surface S5 maintain the high roughness and the corner area C may have a curved shape. Therefore, the side surface S4 and the upper surface S5 of the second catalyst electrode 130 may have higher surface roughness than the side surface S3 of the polymer electrolyte membrane 120.

Next, in the case of the example embodiment of FIG. 6, the polymer electrolyte membrane 120 has a structure extended to cover the side surface S4 of the second catalyst electrode 130. Accordingly, the interface between the polymer electrolyte membrane 120 and the second catalyst electrode 130 may increase, thereby improving the material transfer between the polymer electrolyte membrane 120 and the second catalyst electrode 130 and reaction efficiency in the second catalyst electrode 130. As an example to obtain the structure similar to this modification, after forming the second catalyst electrode 130, the polymer electrolyte membrane 120 may be additionally formed around the second catalyst electrode 130.

Next, in the case of the example embodiment of FIG. 7, the second catalyst electrode 130 has a wider structure than the first catalyst electrode 110. As in this modification, by relatively increasing the width of the second catalyst electrode 130, the interface between the polymer electrolyte membrane 120 and the second catalyst electrode 130 increases, so the material transfer between the polymer electrolyte membrane 120 and the second catalyst electrode 130 and the reaction efficiency in the second catalyst electrode 130 may be improved. In this case, as illustrated, the second catalyst electrode 130 and the polymer electrolyte membrane 120 may have substantially the same width. In this way, in order to form the second catalyst electrode 130 and the polymer electrolyte membrane 120 to have the same width, the second catalyst electrode 130 and the polymer electrolyte membrane 120 may be individualized through the same cutting process. In this case, the side surface S1 and upper surface S2 of the first catalyst electrode 110 have higher surface roughness than the side surface S3 of the polymer electrolyte membrane 120 and the side surface S4 of the second catalyst electrode 130.

Next, in the case of the example embodiment of FIG. 8, gas diffusion layers 141 and 142 are further provided outside the catalyst electrodes 110 and 130, and FIG. 9 is an enlarged view of one area of the gas diffusion layer. Specifically, the first gas diffusion layer 141 disposed below the first catalyst electrode 110 and the second gas diffusion layer 142 disposed over the second catalyst electrode 130 are further provided. These gas diffusion layers 141 and 142 may be implemented as a porous transport layer (PTL), and it is desirable to have a form that is excellent in durability and efficiency even at high current operating density. The gas diffusion layers 141 and 142 may perform a role of discharging oxygen bubbles within the stack of the water electrolysis cell, facilitating the electrolyte penetration into the electrode surface, and conducting the electricity between the electrode and the separator. In order to perform this function, as an example, the first gas diffusion layer 141 may include fibers 160 based on materials such as titanium (Ti), and in addition may also be implemented in the form of felt, mesh, sintered powder, etc. As an example, the second gas diffusion layer 142 may be implemented using carbon fiber and may have a similar shape to the first gas diffusion layer 141.

A spacer 150 may be disposed between the polymer electrolyte membrane 120 and the second gas diffusion layer 142 to surround the second catalyst electrode 130. The spacer 150 may function as a gasket to prevent leakage of gas, etc., and may be formed using a polymer material that may be used in the art. However, when the width of the second catalyst electrode 130 is expanded as in the example embodiment of FIG. 7, the second gas diffusion layer 142 may also be applied without the spacer 150.

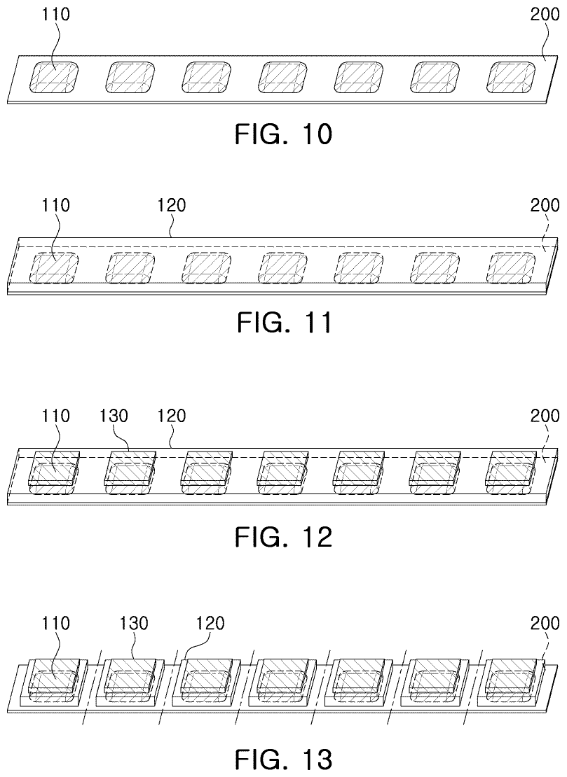

Hereinafter, an example of a method of manufacturing the above-described membrane-electrode assembly will be described with reference to FIGS. 10 through 13. First, the first catalyst electrode 110 is formed on a carrier film 200 (FIG. 10). As the carrier film 200, a PET film, or the like, may be used. The first catalyst electrode 110 may be obtained by printing paste for the first catalyst electrode on the carrier film 200 and then curing the paste, and may be formed in plural to be spaced apart from each other for each membrane-electrode assembly. The paste for the first catalyst electrode may include a first catalyst and an ion conductor, and in addition, may further include a binder, etc. Thereafter, the first catalyst electrode 110 may be formed through the curing step, and at least a portion of the corner area in which the side surface and the upper surface of the first catalyst electrode 110 formed through this process are connected may have a curved shape. In addition, the side surface and the upper surface of the first catalyst electrode 110 may have relatively high roughness, and this shape may be maintained even after the subsequent cutting process.

Next, the polymer electrolyte membrane 120 is formed to cover the side surface and the upper surface of the first catalyst electrode 110 (FIG. 11). The polymer electrolyte membrane 120 may be formed by a method of printing a paste for a polymer electrolyte membrane, etc. The polymer electrolyte membrane 120 may be formed as an integrated structure to cover the plurality of first catalyst electrodes 110 as a whole. In the case of the present example embodiment, unlike the related art, after forming the first catalyst electrode 110, the polymer electrolyte membrane 120 is formed to cover the side surface and the upper surface of the first catalyst electrode 110, so there is an advantage that there is no need to separately insert the support inside the polymer electrolyte membrane 120 or invert the polymer electrolyte membrane 120 during the process to form the catalyst electrode on both surfaces.

Next, the second catalyst electrode 130 is formed on the polymer electrolyte membrane 120 (FIG. 12). Similar to the method of forming the first catalyst electrode 110, the second catalyst electrode 130 may be obtained by printing the paste for the second catalyst electrode on the polymer electrolyte membrane 120 and then curing the paste, and may be formed in plural to be spaced apart from each other for each membrane-electrode assembly. The paste for the second catalyst electrode may include a second catalyst and an ion conductor, and in addition, may further include a binder, etc. Thereafter, the second catalyst electrode 130 may be formed through the curing step, and at least a portion of the corner area in which the side surface and the upper surface of the second catalyst electrode 130 formed through this process are connected may have a curved shape. In addition, the side surface and the upper surface of the second catalyst electrode 130 may have relatively high roughness, and this shape may be maintained even after the subsequent cutting process.

Next, the polymer electrolyte membrane 120 formed in an integrated structure is cut for each membrane-electrode assembly unit to be individualized (FIG. 13). The cutting process may use a mechanical cutting method that may be used in the art. Through the cutting process, the side surface of the polymer electrolyte membrane 120 may have a relatively low roughness. Specifically, the side surface and the upper surface of the first catalyst electrode 110 may have lower roughness than the side surface and the upper surface of the second catalyst electrode 130. Thereafter, the carrier film 200 may be separated to obtain the membrane-electrode assembly.

According to the membrane-electrode assembly according to an example of the present disclosure, it is possible for the electrolyte membrane to have the high level of ionic conductivity and improve the reaction efficiency. Therefore, it is possible to improve the performance of the membrane-electrode assembly when the membrane-electrode assembly is used as a fuel cell or a water electrolysis cell.

While the exemplary embodiments have been shown and described above, it will be apparent to those skilled in the art that modifications and variations could be made without departing from the scope of the present disclosure as defined by the appended claims.

What is claimed is:

1. A membrane-electrode assembly, comprising:
a first catalyst electrode having an upper surface and a side surface connected to the upper surface, at least a portion of the corner area connecting the side surface and the upper surface being curved;
a polymer electrolyte membrane covering a side surface and an upper surface of the first catalyst electrode; and
a second catalyst electrode disposed on the polymer electrolyte membrane.

2. The membrane-electrode assembly according to claim 1, wherein the side surface of the first catalyst electrode has an inclined surface inclined with respect to an upper or lower surface of the polymer electrolyte membrane.

3. The membrane-electrode assembly according to claim 1, wherein a side surface of the polymer electrolyte membrane is disposed to be perpendicular with respect to an upper or lower surface of the polymer electrolyte membrane.

4. The membrane-electrode assembly according to claim 1, wherein the side surface and the upper surface of the first catalyst electrode have a higher surface roughness than a side surface of the polymer electrolyte membrane.

5. The membrane-electrode assembly according to claim 1, wherein at least a portion of the corner area in which a side surface and an upper surface of the second catalyst electrode are connected has a curved shape.

6. The membrane-electrode assembly according to claim 5, wherein the side surface of the second catalyst electrode has an inclined surface inclined with respect to an upper or lower surface of the polymer electrolyte membrane.

7. The membrane-electrode assembly according to claim 5, wherein the side surface and the upper surface of the second catalyst electrode have a higher surface roughness than a side surface of the polymer electrolyte membrane.

8. The membrane-electrode assembly according to claim 1, wherein the polymer electrolyte membrane covers a side surface of the second catalyst electrode.

9. The membrane-electrode assembly according to claim 1, wherein a width of the second catalyst electrode is wider than that of the first catalyst electrode.

10. The membrane-electrode assembly according to claim 9, wherein the second catalyst electrode and the polymer electrolyte membrane have substantially same width.

11. The membrane-electrode assembly according to claim 10, wherein the side surface and the upper surface of the first catalyst electrode have a higher surface roughness than a side surface of the polymer electrolyte membrane and a side surface of the second catalyst electrode.

12. The membrane-electrode assembly according to claim 1, further comprising:
a first gas diffusion layer disposed below the first catalyst electrode; and
a second gas diffusion layer disposed over the second catalyst electrode.

13. The membrane-electrode assembly according to claim 12, further comprising a spacer disposed between the polymer electrolyte membrane and the second gas diffusion layer to surround the second catalyst electrode.

14. A membrane-electrode assembly, comprising:
a first catalyst electrode;
a polymer electrolyte membrane covering a side surface and an upper surface of the first catalyst electrode; and
a second catalyst electrode disposed on the polymer electrolyte membrane,
wherein the side surface and the upper surface of the first catalyst electrode have a higher surface roughness than a side surface of the polymer electrolyte membrane.

15. The membrane-electrode assembly according to claim 14, wherein a side surface and an upper surface of the second catalyst electrode have a higher surface roughness than the side surface of the polymer electrolyte membrane.

16. A membrane-electrode assembly, comprising:
a first catalyst electrode having an upper surface connected to a side surface thereof by a curved portion, the upper and side surfaces having a first surface roughness;
a polymer electrolyte membrane covering the upper and side surfaces of the first catalyst, and having a side surface with a second surface roughness smaller than the first surface roughness; and
a second catalyst electrode disposed over the polymer electrolyte membrane.

17. The membrane-electrode assembly of claim 16, wherein a side surface and an upper surface of the second catalyst electrode have a third surface roughness higher than the second surface roughness.

18. The membrane-electrode assembly of claim 16, wherein the polymer electrolyte membrane covers at least a side surface of the second catalyst electrode.
